(19) United States
(12) Patent Application Publication
(10) Pub. No.: US 2007/0110167 A1
(43) Pub. Date: May 17, 2007

(54) Digital television signal, digital television receiver, and method of processing digital television signal

(76) Inventor: Jin Pil Kim, Seoul (KR)

Correspondence Address: MCKENNA LONG & ALDRIDGE LLP;Song K. Jung, 1900 K Street, N.W., Washington, DC, 20006, US

(21) Appl. No.: 11/449,616

(22) Filed: Jun. 9, 2006

(30) Foreign Application Priority Data
Nov. 16, 2005 (KR) 10-2005-0109896

(51) Int. Cl. H04N 5/445; H04N 11/02

(52) U.S. Cl. 375/240.25; 725/38

(57) ABSTRACT

A digital television (DTV) signal for use in a DTV receiver includes an extended text table (ETT) which includes a header and a message body. The header includes a table identification (ID) extension field which serves to establish uniqueness of the ETT, and the message body includes an extended text message (ETM). The table ID extension field includes an event or source identification. The header further includes an information field indicating that the table ID extension field includes the event or source identification for establishing the uniqueness of the ETT. A section-filtering unit included in the DTV receiver is able to use this information field for section-filtering a pertinent event or channel ETT from a plurality of ETTs in an efficient manner.

This application claims the benefit of the Korean Patent Application No. 10-2005-0109896, filed on Nov. 16, 2005, which is hereby incorporated by reference as if fully set forth herein.

### BACKGROUND OF THE INVENTION

1. Field of the Invention

The present invention relates to a program and system information protocol (PSIP) table in a digital broadcasting, and more particularly, to a television signal including tables within PSIP, apparatus for processing the same and method thereof.

2. Discussion of the Related Art

Generally, a program and system information protocol (hereinafter abbreviated PSIP) is used as a protocol for a channel tuning and broadcast schedule transfer in ATSC (advanced television systems committee) as the digital broadcasting in terrestrial and cable digital broadcasting environments.

And, the PSIP is the protocol for a transfer of tables included within packets transferred by a multiplexed transport stream. The tables having the specific purpose, respectively are identified and basically have a section structure that of PSI (program and system information) of MPEG (moving picture experts group) as identified tables in the PSIP.

Each table of the PSIP is constructed structure of sections to be transferred. In particular, the tables can be constructed one section or a plurality of sections corresponding to kind of table. In particular, each of the sections can be divided into a necessary table to be selectively received specific section, a header including basic information of the section and a message body including actual data of the table.

As mentioned in the above description, the section-filtering of the receiver is defined that the receiver can be received the specific section to parse the header of one or a plurality section is constructed table.

However, the receiver can not be received the specific section by the section-filtering. In particularly, if the receiver is parsed the body of each of the sections, the receiver takes too much time to collect a specific table data. Finally, system efficiency of the receiver is lowered. Moreover, a transmitting end transmits the television signal including the PSIP table by one of various type methods. If there exists no information of the transmitting method, it is difficult for a receiver to decode the television signal appropriately.

### SUMMARY OF THE INVENTION

Accordingly, the present invention is directed to a television signal including a PSIP table, apparatus for receiving the same and method thereof that substantially obviate one or more problems due to limitations and disadvantages of the related art.

An object of the present invention is to provide a television signal in a digital television receiver.

Another object of the present invention is to provide an apparatus for receiving the television signal and method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital television (DTV) signal for use in a digital television (DTV) receiver includes an event extended text table (ETT) which includes a header and a message body. The header includes a table identification (ID) extension field which serves to establish uniqueness of the event ETT. The message body includes an extended text message (ETM). The table ID extension field includes an event identification of an event associated with the event ETT. The header further includes an information field indicating that the table ID extension field includes the event identification to establish the uniqueness of the event ETT.

In another aspect of the present invention, a digital television (DTV) signal for use in a digital television (DTV) receiver includes a channel extended text table (ETT) which includes a header and a message body. The header includes a table identification (ID) extension field which serves to establish uniqueness of the channel ETT. The message body includes an extended text message (ETM). The table ID extension field includes a source identification of a virtual channel associated with the channel ETT. The header further includes an information field indicating that the table ID extension field includes the source identification to establish the uniqueness of the channel ETT.

In another aspect of the present invention, a digital television (DTV) receiver includes a tuner, a demodulator, and a section-filtering unit (e.g., a demultiplexer). The tuner is tuned to receive a digital television (DTV) signal, and the demodulator demodulates the DTV signal. The demodulated signal includes a plurality of extended text tables (ETTs). Each ETT includes a header containing a table identification (ID) extension field which serves to establish uniqueness of each ETT. The section-filtering unit detects at least one pertinent ETT by section-filtering the plurality of ETTs using their PIDs and table ID extension fields. The plurality of ETTs are section-filtered based on a first condition that an information field included in a header of the at least one pertinent ETT has a predefined value. The information field having the predefined value indicates that a table ID extension field included in the pertinent ETT includes an event or source identification to establish uniqueness of the pertinent ETT.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of a general syntax of a PSIP table associated with the present invention;

FIG. 2 is a diagram of a bit stream syntax of channel ETT according to the present invention;

FIG. 3 is a diagram of a bit stream syntax of event ETT according to the present invention;

FIG. 4 is a block diagram of a digital television receiver to receive channel and event ETT according to the present invention;

FIG. 5 is a diagram of an EPG display according to one embodiment of the present invention;

FIG. 6 is a conceptional diagram of a structure of a database (DB) associated with the present invention;

FIG. 7 is a diagram for explaining a type of an ETT transmitter associated with the present invention;

FIG. 8A is a flowchart of a process for receiving a specific channel ETT section according to the present invention;

FIG. 8B is a flowchart of a process for receiving a specific event ETT section according to the present invention; and

FIG. 9 is a flowchart of a process for receiving a new ETT section only by discarding an overlapped ETT section according to the present invention.

### DETAILED DESCRIPTION OF THE INVENTION

Reference will now be made in detail to a television signal including a PSIP (program and system information protocol) table, apparatus for receiving the same and method thereof according to the preferred embodiments of the present invention, examples of which are illustrated in the accompanying drawings. Wherever possible, the same reference numbers will be used throughout the drawings to refer to the same or like parts.

First of all, terminologies used in the description of the present invention are defined as considering functions in the present invention, which are variable according to usual practice or intentions of those who skilled in the art. Hence, their definitions shall be given based on the overall contents of the present invention.

### First Embodiment

The present invention relates to an ETT (extended text table) as a PSIP table included in a television signal. The PSIP table is preferentially explained prior to description of the ETT.

As the PSIP table, there is a virtual channel table (VCT) having information about a virtual channel viewed by a user in a receiving apparatus, an EIT (event information table) enabling an EPG (electronics program guide) service, an ETT for the EIT or the like.

The EIT contains information (titles, start times, etc) for events on defined virtual channels. The event is, in most cases, a typical television program. Up to 128 EITs may be transmitted and each of them is referred to as EIT-k, with k=0, 1, . . . , 127. And, each EIT is represented as information of three-hour unit. Moreover, each EIT can have information about at least one event.

The ETT contains extended text message (ETM) streams, which are optional and are used to provide detailed descriptions of virtual channels (channel ETM) and events (event ETM). An ETM is a multiple string data structure, and thus, it may represent a description in several different languages.

The event ETT is mapped to each EIT. In particular, information for events belonging to EIT-0 to EIT-127 is recorded at ETT-0 to ETT-127, respectively. In this case, information about at least one or more events included in each EIT can be represented as one section. Each of the events has a unique event identification. And, each of the events is identified by the corresponding event identification. And, ETM location indicates a presence or non-presence of an extended text message (ETM) for each of the events and a location of each of the events.

The channel ETT is used in case that channel information having a more extended meaning is required for n-virtual channels included in one physical channel. In this case, each of the n-virtual channels defined in the VCT uses source identification in identifying each channel source. In particular, if there are n-virtual channels in one physical channel, each of the virtual channels has a source identification. In this case, the source identification should have a unique value. And, ETM location defined in VCT decides whether a channel ETT exists in each of the virtual channels. The ETM location indicates a presence or non-presence of an extended text message (ETM) in each of the virtual channels and a location of each of the virtual channels, which is equivalent to that of the event ETT.

Each of the channel and event ETTs can be constructed with at least one or more sections. Each of the sections includes ETM identification identifying the corresponding ETT and an extended text message (ETM) about the corresponding ETT. In this case, the ETM identification is linked to event ETM identification of a corresponding event in case of the event ETT section or to channel ETM identification of a corresponding virtual channel in case of the channel ETT section.

The present invention relates to the ETT among PSIP tables. In transmitting the ETT, a transmitting end uses one of three kinds of transmitting methods. Hence, a receiving end needs information for the transmitting method to appropriately receive the transmitted ETT sections. To provide the information, the present invention intends to define the information using a reserved field configuring a header of each of the ETT sections. The three kinds of the transmitting methods will be explained in detail later.

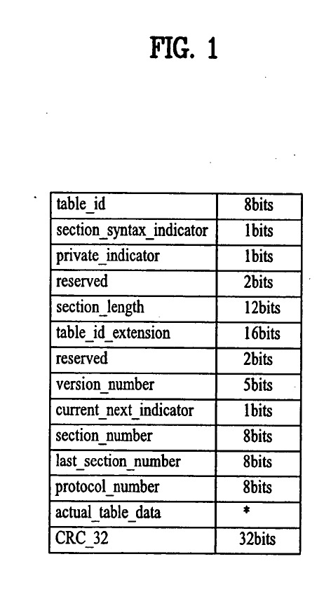

Besides, the receiving apparatus performs a section-filtering on each of the received ETT sections. A structure of the section is preferentially explained prior to the section-filtering. FIG. 1 is a diagram of a general syntax of a PSIP table associated with the present invention.

In this case, the section is constructed by combining data structures. Each of the sections starts from table identification field and ends to CRC-32 field. A table section of the syntax shown in FIG. 1 is divided into a header having a mutually common form, a message body recording actual data according to the purpose of the table section, and a trailer for an error check and correction of the table section. The header starts from table identification field to protocol version field. The message body starts from ETM identification field to extended text message field. And, the trailer is CRC 32 field. Besides, the respective fields will be explained in detail later.

As mentioned in the foregoing description, the receiving apparatus performs the section-filtering on each of the ETT sections. In the present invention, the section-filtering, which was already received and is overlapped with another, is discarded. And, the section-filtering is carried out only if a new or specific section is received. In particular, the present invention intends to carry out the section-filtering in a manner of filtering a header of the received section only.

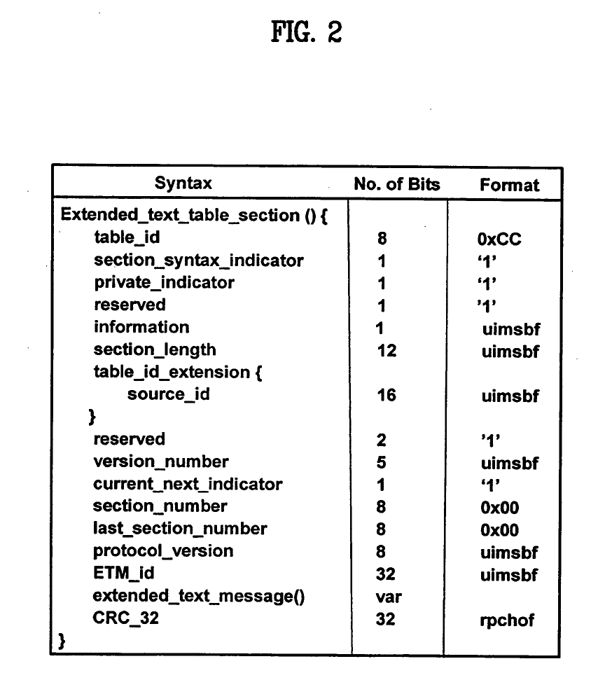

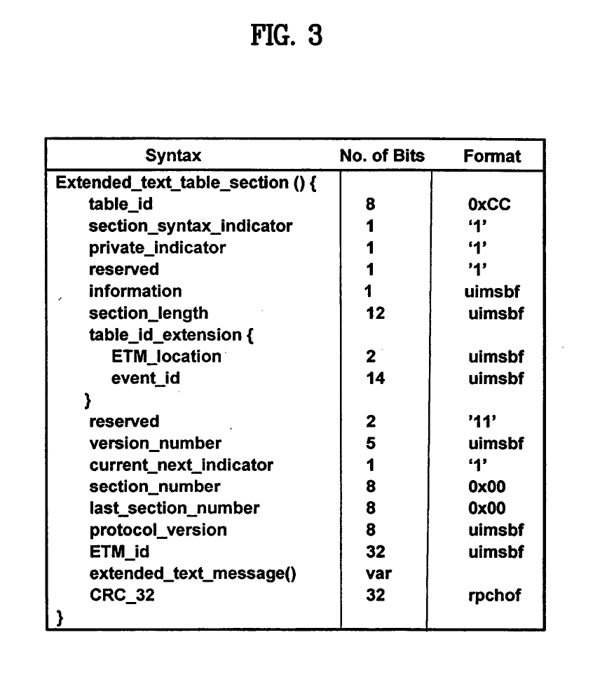

A syntax configured to enable section-filtering carried out on the header only according to the present invention is explained as follows. FIG. 2 is an exemplary diagram of a bit stream syntax of channel ETT according to the present invention, and FIG. 3 is an exemplary diagram of a bit stream syntax of event ETT according to the present invention.

In the present invention, a header is filtered only and the section-filtering is carried out using ETT table ID extension field among fields constructing the header of the table section. Fields constructing the syntaxes shown in FIGS. 1 to 3 are explained as follows. For simple and clear explanation, English expression of the syntax is used as it is but is marked by double quotation marks.

First of all, each field constructing a header of the syntax is explained as follows. The “table_id” identifies the section as belonging to an ETT and is an 8-bit field. The “section_syntax_indicator” is set to ‘1’ and is a 1-bit field. It denotes that the section follows the generic section syntax beyond the section length field. The “private_indicator” is set to ‘1’ and is a 1-bit field.

The “information” is a 1-bit field corresponding to uimsbf (unsigned integer, most significant bit first) and can have a variable value. In this case, the information field according to the present invention uses one of two reserved fields existing within the header. In particular, the present invention uses one of the two reserved fields and the used field is a 2-bit field. One bit of the two bits is assigned to the “information” field and the rest one bit is assigned as a reserved bit as it is for example. Namely, the reserved field having two bits is divided to use one bit for the reserved field and to define the rest one bit as the information field of the present invention. This can be applied to the case of using the rest reserved field in the same manner. As the information field is constructed with one bit, two cases can be represented. Namely, the information field can represent whether it is set or not. If it is set, a value of the field is ‘0’. If it is not set, a value of the field is ‘1’.

The value of the information field is associated with a type of a transmitter. And, there exist three types of the transmitter. A first type corresponds to a case that a value of ETT table identification (ID) extension field is ‘0x0000’, a second type corresponds to a case that a value of ETT table ID extension field is a uniqueness value, and a third type corresponds to a case that a value of ETT table ID extension field is source identification or event identification. ETT of the third type has a table type of FIG. 2 or FIG. 3. And, each of the first and second types will have a table type of FIG. 1. Hence, ‘the information field is set’ means that transmission is made by the third type transmitter. And, ‘the information field is not set’ means that transmission is made by the first or second type transmitter.

So, by deciding a presence or non-presence of setting according to the information field value, the type of the transmitter can be known. Hence, the receiver can appropriately cope with the received ETT sections. Namely, in the present invention, it can be informed that the ETT section is transmitted by what type of the transmitter among the three types using the information field. If the information field is set, source identification or event identification shall exist in the ETT table ID extension field. If the information field is not set, a uniqueness value or ‘0x0000’ shall exist in the ETT table ID extension field.

The “section_length” field is to specify the number of remaining bytes in the section immediately following the section length field up to the end of the section. The value of the section length shall be no larger than 4,093. The “ETT table_id_extension” is a 16-field. The ETT table ID extension field is associated with the present invention, and the field can have three kinds of values. To correspond to the first to third type transmitters, the field has one of ‘0x0000’, ‘uniqueness value’ and ‘source identification or event identification’.

The “version_number” is a 5-bit field. For the channel ETT, the field indicates the version number of the channel ETT. The version number shall be incremented by 1 modulo 32 when any ETM in the channel ETT changes. For event ETT, the field indicates the version number of event ETT-i, where ‘i’, as in the EIT case, is the index of time span. The version number shall be incremented by 1 modulo 32 when any ETM in the event ETT-j when ‘j’ is not equal to i. The value of this field shall be identical to that of the corresponding entry in the MGT (master guide table).

The “current_next_indicator” is a 1-bit indicator and is always set to ‘1’ for the ETT sections. The ETT sent is always currently applicable. The “section_number” is an 8-bit field and the value of the field shall always be ‘00x00’. The “last_section_number” is an 8-bit field and the value of the field shall always be ‘00x00’. The ‘protocol_version” is an 8-bit unsigned integer field whose function is to allow, in the future, this table type to carry parameters that may be structured differently than those defined in the current protocol. At present, the only valid value for protocol version is zero. Non-zero values of protocol version may be used by a future version to indicate structurally different tables.

Secondly, fields of the message body are explained as follows. The “ETM_id” field is unique 32-bit identifier of this extended text message (ETM). The identifier follows a regular rule. By the rule, in case of channel ETM identification, source identification is written in a most significant bit (MSB) b31 and two least significant bits (LSB) b1 and b0 are written as ‘00’. By the rule, in case of event ETM identification, source identification is written in a most significant bit (MSB) b31, event identification is written in a bit b15, and ‘10’ is written in least significant bits (LSB) b1 and b0. The “extended_text_message( )” field indicates the extended text message (ETM) in the format of a multiple string structure.

Finally, a field of the trailer is explained as follows. The “CRC_{—}32” field is a 32-bit field that contains the CRC value that ensures a zero output from the registers in the decoder after processing the entire Transport Stream ETT section.

The syntaxes of FIG. 2 and FIG. 3 according to the present invention use the general syntax of the PSIP of FIG. 1 as it is. And, the syntaxes of FIG. 2 and FIG. 3 indicates what transmitter transmits the information existing in the ETT table ID extension field using the information field within the header for the section-filtering by the header. In doing so, as mentioned in the foregoing description, the information uses a portion of bits within a reserved field. Namely, the present invention performs a section-filtering by filtering the header of the ETT section (channel or event) having the detailed information about the virtual channel and event. Hence, by the present invention, a new or specific section among the received ETT sections can be selectively received per channel or event without being overlapped with another.

For this, in the present invention, the information field is linked to the ETT table ID extension field of the ETT. Namely, if the information field value is set, event identification and ETM location are included in ETT table ID extension in case of the event ETT section. In case of the channel ETT section, source identification is included in ETT table ID extension.

The “ETT table_id_extension” is provided to indicate individuality of each ETT instance if the ETT exists in transport stream packets having a common PID (packet identifier). A table type of the ETT can be previously known from MGT before the ETT is received. In particular, the table type of the ETT is “0x0004” in case of channel ETT or “0x0200-0x027F” in case of event ETT.

FIG. 2 shows a channel ETT having an ETT table type of “0x0004”. In this case, 16-bit source identification connecting the VCT to channel ETT is written in the ETT table ID extension. And, the source identification should have the same value of source identification written in VCT and ETM identification.

FIG. 3 shows an event ETT having an ETT table type of “0x0200˜0x027F”. In this case, the ETT table ID extension has a 16-bit value if the information field value is set. Namely, ETM location is written two bits of the sixteen bits and unique event identification connecting the VCT to event ETT is written in fourteen bits. In this case, the event identification should have the same value of an event identification value of the corresponding event of EIT-k and an event identification value in the ETM identification should have the same value as well. By means of the information and ETT table ID extension fields constructing the header of each of the received ETT sections (channel or event), the section-filtering is enabled with the header only without parsing a message body of each of the received ETT sections.

Namely, in the present invention, the information field is set and the event identification and source identification are written in the ETT table ID extension field. And, the header including the information and ETT table ID extension fields of each of the received ETT sections is filtered. By filtering the header including the information and ETT table ID extension fields, the section-filtering can be performed to receive a new ETT section only by discarding an ETT section, which was already received and is overlapped with another, or to receive a specific ETT section only. Hence, in performing the section-filtering on each of the received ETT sections, the message body of each of the ETT sections needs not to be parsed. As mentioned in the foregoing description, by receiving a new or specific ETT section in a manner of filtering off an overlapped or unspecific ETT section, a process time can be reduced to raise system efficiency. The more the ETT sections exist, the more efficient the system gets.

### Second Embodiment

A digital television (DTV) receiver to receive a television signal including an ETT according to a second embodiment of the present invention is explained as follows.

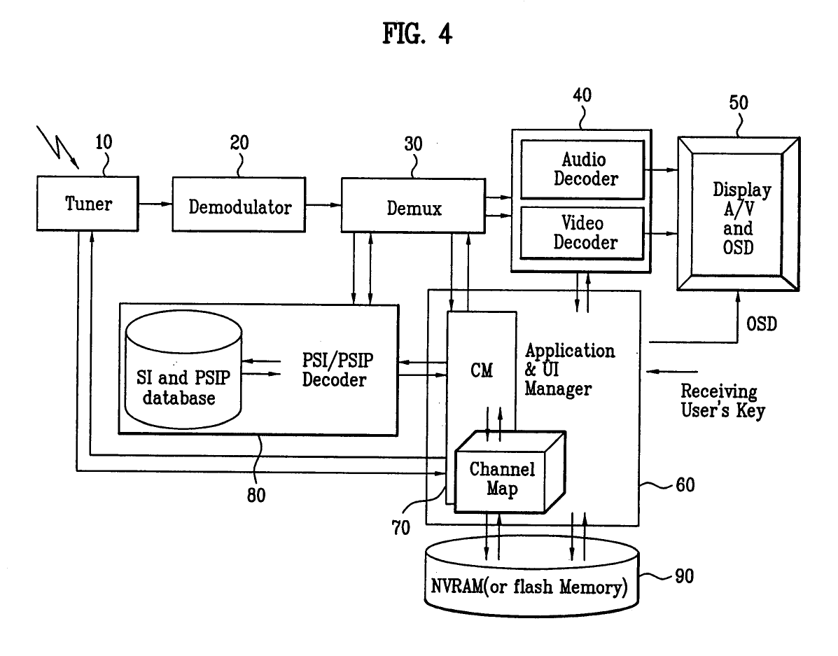

FIG. 4 is a block diagram of a digital television receiver to receive channel ETT and event ETT according to the present invention. Referring to FIG. 4, a digital television system receives and processes tables and audio/video transport streams according to the present invention.

A tuner 10 receives a terrestrial or cable digital television (DTV) signal via an antenna. In this case, a reception process of the tuner 10 is controlled by a channel manager 70. In particular, the tuner 10 reports a result and strength of the television signal received by the receiver and transfers the television signal received by the receiver to a demodulator 20. In case that a terrestrial broadcasting is received, the demodulator 20 performs 64- or 256-VSB (vestigial sideband) demodulation. In case that a cable broadcasting is received, the demodulator 20 performs 64- or 256-QAM (quadrature amplitude modulation) demodulation. And, the demodulator 20 transfers a demodulated signal to a demultiplexer 30.

The digital television system shown in FIG. 4 is divided into one part performing a section-filtering on a received ETT section by a header and the other part parsing the received ETT section. In this case, the section-filtering part is conducted by the demultiplexer (DEMUX) 30 and the parsing part is conducted by a PSI/PSIP decoder 80.

First of all, the section-filtering part is explained as follows. The demultiplexer 30 performs demultiplexing to filter off audio, video and PSI/PSIP tables from transport packets transferred from the demodulator 20. Demultiplexing of the PSI/PSIP table is carried out under the control of the PSI/PSIP decoder 80. In particular, the demultiplexer 30 checks a header in common to the PSI/PSIP table to perform the section-filtering on the received PSI/PSIP table.

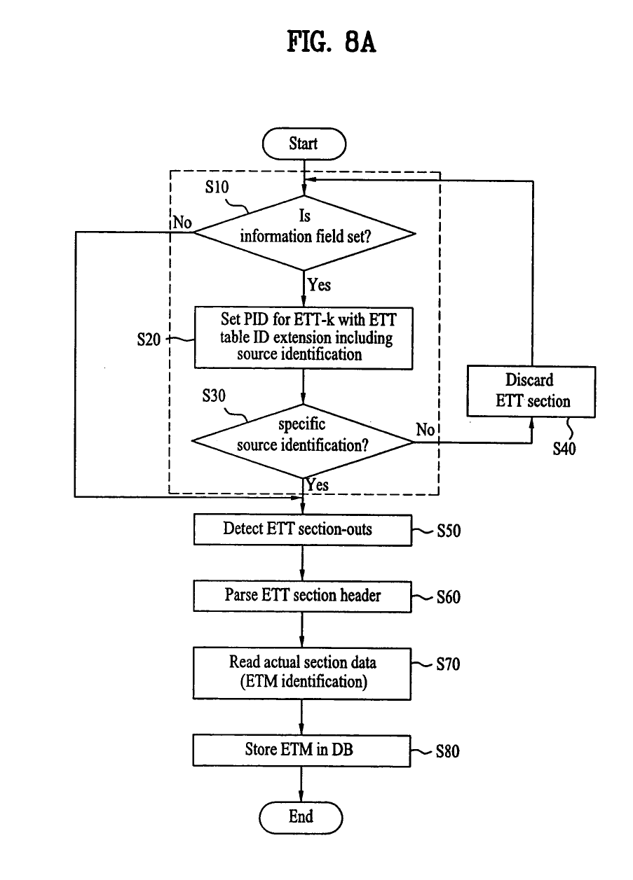

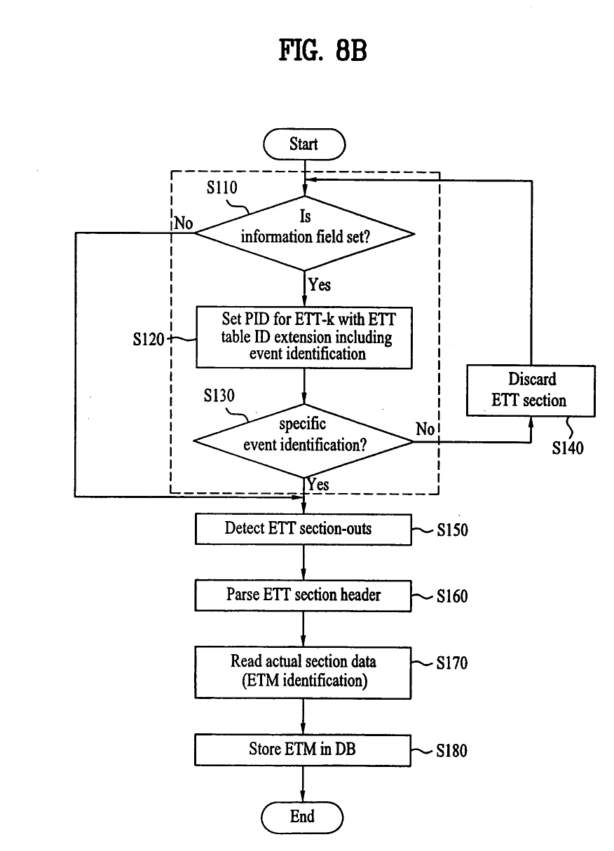

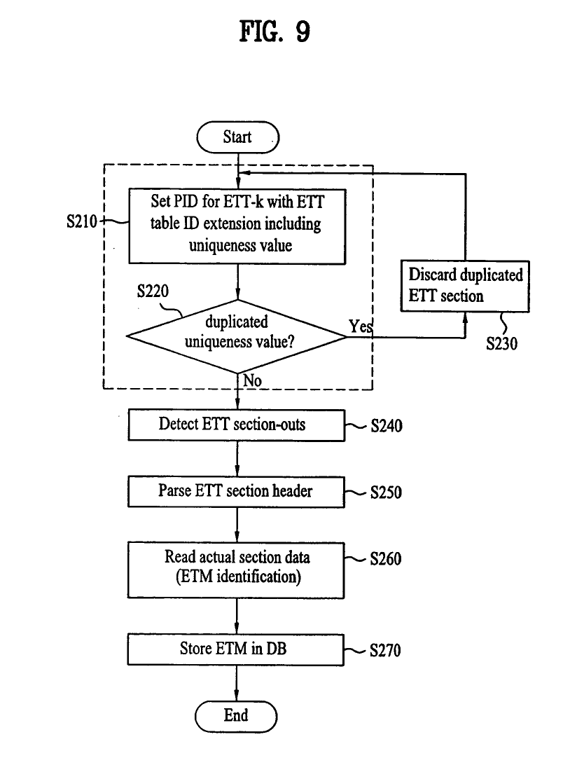

In doing so, the information field and ETT table ID extension field within the header are checked. The demultiplexer 30 generates a section of the PSI/PSIP table and then transfers it to the PSI/PSIP decoder 80. In particular, it is detected whether the information field value is set. If the information field value is set, it can be known that source identification or event identification is written in the ETT table ID extension field. And, a filtering condition for a section-filtering is determined according to the information. The section-filtering condition will be explained with reference to FIGS. 8A to 9 later. And, the demultiplexer 30 generates a section of the PSI/PSIP table and then transfers it to the PSI/PSIP decoder 80.

Demultiplexing of the Audio/Video transport packets is carried out under the control of the channel manager 70. In particular, if an Audio/Video packet identifier (PID) of a corresponding virtual channel is set, the demultiplexer 30 demultiplexes an elementary stream of the Audio/Video to transfer to an Audio/Video decoder 40. Hence, the demultiplexer 30 performs the section-filtering on the Audio/Video data, PSI/PSIP table and the like in a manner of filtering the header only. And, data for each section generated from the section-filtering is transferred to the corresponding decoder.

The corresponding decoder is explained as follows. The Audio/Video decoder 40 decodes elementary stream packets of Audio/Video transferred from the demultiplexer 30 by MPEG2/AC3. The Audio/Video decoder 40 synchronizes the decoded Audio/Video data by a VDP (video display processor) and then transfers it to an output unit, i.e., an Audio/Video & OSD (on screen display) displayer 50. The Audio/Video & OSD displayer 50 receives the decoded Audio/Video data transferred from the Audio/Video decoder 40 and then displays the received Audio/Video data via screen/speaker. In this case, the Audio/Video & OSD displayer 50 is under the control of OSD graphic data in case of displaying the data via the screen. In case that there is a key input of a viewer watching the digital television, an application & UI (user interface) manager 60 responds to a viewer's request by displaying it on the screen via a GUI (graphic user interface).

The application & UI manager 60 receives a decoded state of the audio/video signal from the Audio/Video decoder 40 and then controls the displayer 50 via the OSD according to the received audio/video state.

And, the application & UI manager 60 controls the channel manager 70 to perform channel associated management, i.e., channel map management and to manage the PSI/PSIP decoder 80. Moreover, the application & UI manager 60 stores/restores GUI control of the entire digital television (DTV) receiver, user's request and a state of the receiver in/from a NVRAM or flash memory 90. Furthermore, the application & UI manager 60 includes the channel manager 70.

The channel manager 70 manages the channel map by controlling the tuner 10 and the PSI/PSIP decoder 80 to meet a channel request made by a viewer. The channel manager 70 requests the PSI/PSIP decoder 80 to parse a table associated with a channel to be tuned and receives a report of parsing the table from the PSI/PSIP decoder 80. The channel manager 70 updates the channel map according to the reported parsing result and makes a decoding request by setting the audio/video PID in the demultiplexer 30.

Meanwhile, the PSI/PSIP decoder 80 corresponding to the table parsing part is explained as follows. The PSI/PSIP decoder 80, which is a PSI and PSIP control module, performs a slave operation under the control of the channel manager 70. Namely, the PSI/PSIP decoder 80 sets PIDs of the PSI/PSIP tables in the demultiplexer 30. The PSI/PSIP decoder 80 receives and parses the PSI section for an MPEG2 system and generates a PSI database. And, the PSI/PSIP decoder 80 receives and parses the PSIP section for ATSC and generates a SI/PSIP database (DB).

In performing a parsing, the PSI/PSIP decoder 80 reads a rest actual section data portion, on which the section-filtering is not performed or cannot be performed, and then records it in the SI/PSIP database (DB).

### Third Embodiment

A method of performing a section-filtering by filtering a header of a received ETT section only according to another embodiment of the present invention is explained as follows. Specifically, in performing the section-filtering, a method of checking and handling information and ETT table ID extension fields included in a header of a received ETT section is explained as follows.

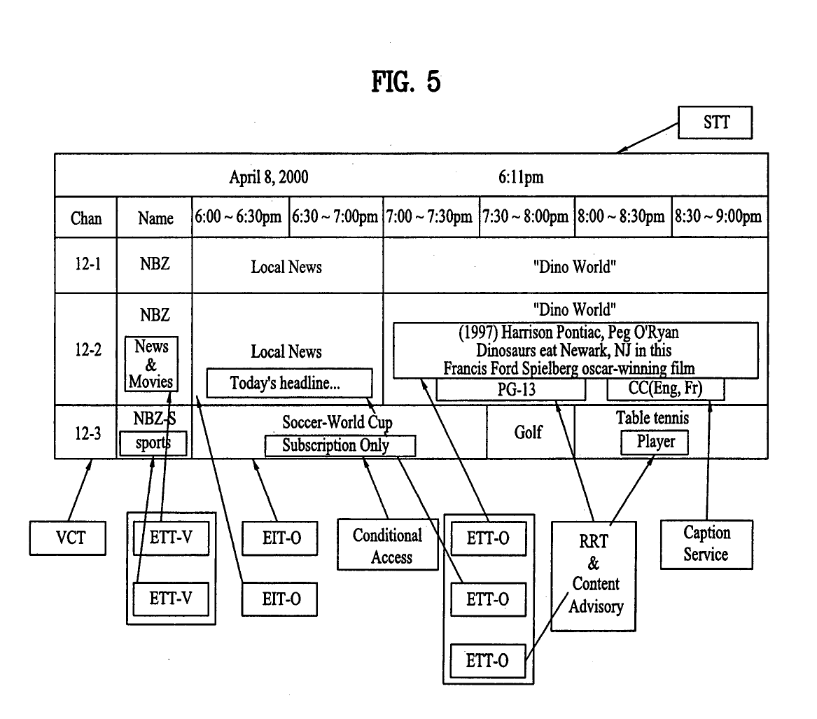

An EPG is preferentially explained prior to the embodiment. FIG. 5 is a diagram of an EPG display according to one embodiment of the present invention. Referring to FIG. 5, an EPG includes VCT (virtual channel table), channel ETT, EIT and event ETT.

Information of a current date and time at a most upper end on an EPG screen is delivered via STT (system time table) and exemplarily shows “Apr. 8, 2000 6:11 pm”. A most left side “Chan” part in FIG. 5 displays channel numbers 12-1, 12-2 and 12-3 of virtual channels delivered from VCT. In this case, each of the virtual channels has source identification having a unique value. A name part follows each of the channels. The name part means a channel short name included in each of the virtual channels and exemplarily shows NBZ1, NBZ2 or NBZ-S.

Each of the virtual channels can send a channel information message having a more extended meaning, which is forwarded via channel ETT-V for each of the virtual channels connected to the source identification gained from the VCT. Although the channel 12-1 is represented as the name “NBZ1”, channel ETT connected to the source identification of the channel does not exist. A channel ETT called “News & Movies” exists in the channel 12-2 and a channel ETT called “sports” exists in the channel 12-3. In this case, instances of the two channel ETTs has the same PID and is represented as ETT-V. And, each instance of the channel ETTs has the same table type, version number, table identification field and the like.

In the channel 12-1, an event having a title of “Local News” at 6:00˜7:00 pm and an event having a title of “Dino World” at 7:00˜9:00 pm exist as broadcast programs. This information is delivered via EIT-0 table having the same value of source identification of a virtual channel 12-1.

In the channel 12-2, an event having a title of “Local News” at 6:00˜7:00 pm and an event having a title of “Dino World” at 7:00˜9:00 pm exist as broadcast programs. This information is delivered via EIT-0 table having the same value of source identification of a virtual channel 12-2. In this case, it is exemplarily shown that each of the events in the channel 12-2 includes a broadcast content message having a more extended content. This is forwarded via event ETT. In the former event, event ETT for the event named “Today's headline . . . ” exists. In the latter event, event ETT named “(1997) Harrison Pontiac, Peg O'Ryan Dinosaurs eat Newark, N.J. in the Francis Ford Spielberg oscar-winning film” exists.

In the channel 12-3, an event having a title of “Soccer-World Cup” at 6:00˜7:30 pm, an event having a title of “Golf” at 7:30˜8:00 pm, and an event (EIT-0) having a title of “Table Tennis” at 8:00˜9:00 pm exist as broadcast programs. These events are delivered via EIT-0 table having the same value of source identification of a virtual channel 12-3. In this case, it is shown that an event ETT (event ETT-v) to forward a broadcast content message having an extended content named “Player” exists in the event having the title named “Table Tennis”.

Hence, in FIG. 5, there exist three event ETTs to forward the broadcast content messages having the extended contents for several events. Each of the event ETTs has the same values of PID, version number, table identification and table type. As can be seen in FIG. 5, if the number of the virtual channels is raised, the number of the instances of the overlapped channels and event ETTs will be increased as well.

As mentioned in the above description of the EPG, the present invention intends to perform a section-filtering on the numerous overlapped channel and event ETTs to receive a new ETT section or a specific section only instead of receiving an ETT section overlapped with a previously received one. In case that a content of the channel ETT is changed (e.g., the version number is changed), one channel ETT that is changed in the above manner can be quickly received.

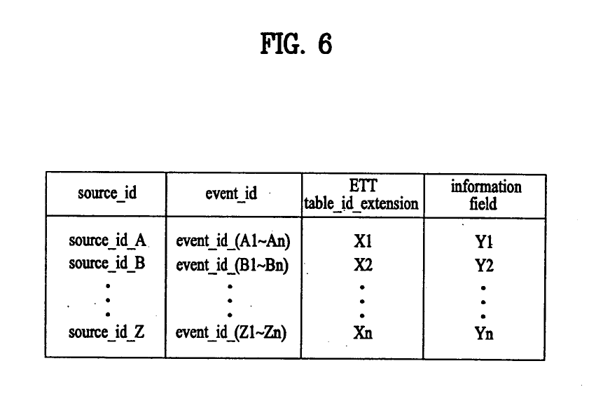

FIG. 6 is a conceptional diagram of a structure of a database (DB) associated with the present invention. Referring to FIG. 6, source identification, event identification, ETT table ID extension field values and an information field value required for receiving ETT section are stored in a database (DB). In this case, the database is a sort of a memory. The database (DB) shown in FIG. 6 includes a part storing the source identification linking VCT and the channel ETT together, a part storing the event identification linking EIT and the event ETT together, a part storing the ETT table ID extension field value, and a part storing the information field value. In this case, the ETT table ID extension field value and the information field value are obtained from parsing the header in the PSI/PSIP decoder 80 and are then stored.

The source identification, as shown in FIG. 6, is represented as “source_id_(A˜Z)”. In this case, the ‘A˜Z’ corresponds to a virtual channel to represent the source identification existing in each of the channels A to Z existing within the VCT. The event identification is represented as “event_id_(A1˜An) to (Z1˜Zn)”. In this case, the ‘A˜Z’ corresponds to a virtual channel and the ‘1˜n’ indicates an event existing in each of the virtual channels. Namely, it means that an event corresponding to A1˜An exists in the virtual channel A. The ETT table ID extension field value is represented as X1˜Xn. In this case, the X1˜Xn means a value written in the ETT table ID extension field of each ETT section. The information field value is represented as Y1˜Yn. In this case, the Y1˜Yn is a value indicating whether each ETT section is set and will have a value ‘0’ or ‘1’. As mentioned in the foregoing description, ‘0’ means that it is set. And, ‘1’ means that it is not set.

A process for performing a section-filtering in a manner of filtering a header of an ETT section received by a receiver according to the present invention is explained as follows. As mentioned in the foregoing description, there exist channel and event ETT, which will be individually explained in the following description. In this case, the section-filtering includes one case of receiving a new ETT section only by discarding an ETT section overlapped with a previously received one and the other case of receiving a specific ETT section only. Moreover, a concept of the section-filtering may include a case of combining the former two cases together.

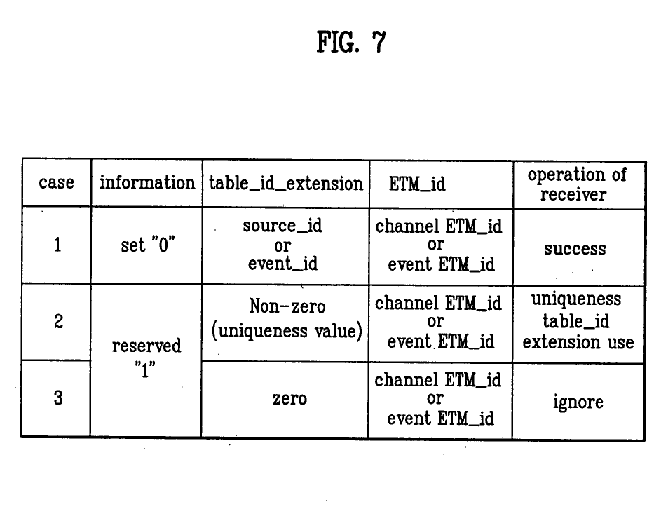

As mentioned in the foregoing description, there exist three types of the transmitters in transmitting ETT. FIG. 7 is a diagram for explaining a type of an ETT transmitter associated with the present invention. Referring to FIG. 7, in handling an ETT section transmitted from one of the types of the transmitters, a receiver is operated in the following three cases 1 to 3.

The cases 1 to 3 are identified from one another according to whether an information field value within a header is set or not. In particular, if the information field value is set, the receiver is operated in the case 1. If the information field value is not set, the receiver is operated in the case 2 or 3. In the case 1, according to a table type of a received ETT section, the ETT table ID extension field within the header includes source identification if the table type is the channel ETT or event identification if the table type is the event ETT. And, ETM identification within the message body includes channel ETM identification or event ETM identification according to the corresponding table type.

Hence, in such a case, the receiver decides ‘success’ and operates. The ‘success’ means that the receiver succeeds in receiving the ETT having a specific source identification or event identification field value by directly controlling the demultiplexer 30. Namely, the case 1 corresponds to the operation of the receiver in extracting a specific ETT table ID extension field value (source identification or event identification). The case 2 or 3 corresponds to a case that the information field value is not set. To identify the case 2 or 3, it is decided whether the field value is ‘0x0000’ by extracting the ETT table ID extension field value.

In particular, if the information field value is not set and if the ETT table ID extension field value is not ‘0x0000’, it is decided as the case 2. Hence, a uniqueness value will be extracted from the ETT table ID extension field within the header read out by the demultiplexer 30. And, the ETM identification within the message body parsed by the PSI/PSIP decoder 80 will correspond to channel ETM identification or event ETM identification read out according to a table type of a corresponding ETT section.

In such a case, the receiver will assume the case of using a uniqueness value as the ETT table ID extension field value. Hence, in case of failing in receiving a specific ETT table ID extension field value in the case 1, the receiver keeps receiving an ETT section to receive a specific field value and discards an overlapped ETT section to receive a new ETT section only by deciding whether the received ETT section is overlapped with a previously received and stored field value. Apart from the case 1, the case 2 is usable in case of attempting to receive a new ETT section by discarding a received overlapped ETT section as well.

And, the case 3 corresponds to a case that the information field value is not set and that an ETT table ID extension field value within the header is ‘0x0000’. In such a case, the demultiplexer 30 within the receiver is unable to perform the section-filtering via the header. Hence, in the case 3, the PSI/PSIP decoder 80 parses message body of all received ETT sections in direct.

The respective cases in FIG. 7 are explained with reference to the flowchart as follows. Since the section-filtering in the demultiplexer 30 is impossible in the case 3, the cases 1 and 2 will be intensively explained in the following description.

First of all, the section-filtering is described with reference to FIGS. 8A to 9 as follows. Once a digital television (DTV) is turned on, a specific channel is previously selected in the digital television (DTV). A receiver receives channel information via VCT, PAT (program association table) or PMT (program map table). And, the receiver assigns an Audio/Video packet identifier (PID) of a specific virtual channel determined by a viewer to the demultiplexer 30. Hence, the viewer watches the specific virtual channel. In the present invention, it is assumed that the viewer requests ETT information of the currently watched specific virtual channel. If a request for the ETT information is made, a section-filtering is initiated by filtering a header only according to the present invention.

As mentioned in the foregoing description, the section-filtering includes one case of receiving a new ETT section only by discarding an ETT section overlapped with a previously received one and the other case of receiving a specific ETT section only. Moreover, a concept of the section-filtering may include a case of combining the former two cases together.

In the following description of the present invention, theses three cases will be taken as examples in the present invention.

FIG. 8A is a flowchart of a process for receiving a specific channel ETT section according to the present invention. As mentioned in the foregoing description, if there is an ETT information request, a section-filtering is carried out to receive a specific ETT section according to the present invention. Namely, if the ETT information is requested, the PSI/PSIP decoder 80 controls the demultiplexer 30 by setting a condition for enabling the section-filtering via header. The demultiplexer 30 then starts filtering a header on the set condition. In particular, the receiver reads out an information field of a received ETT section and then decides whether the information field is set. If the information field is set, it means that a value of the information field is ‘0’ (S10).

As a result of the decision (S10), if the information field is set, a corresponding PID is assigned to the Audio/Video or Data service using a table type acquired from the master guide table (MGT) and an ETT section having the assigned PID is received only. In doing so, a condition for receiving a section including ETT table ID extension field having source identification recorded therein only is applied to the received ETT section having met the former condition. Thus, the receiver performs the section-filtering through the two conditions. Hence, the receiver receives the channel ETT section that meets the two conditions only (S20).

The source identification recorded in ETT table ID extension field of the channel ETT section, which has met the conditions and is received by the receiver, is read out. It is then decided whether the read-out source identification is equal to source identification stored in a database (DB). In particular, it is decided whether the source identification recorded in the ETT table ID extension field of the received channel ETT section is equal to the source identification, which was generated from decoding VCT, stored in the database (DB) (S30).

As a result of the decision (S30), if the two source identification's are not equal to each other, it is decided that the received channel ETT section is not a specific channel ETT section. Hence, the corresponding channel ETT section is discarded. And, it goes back to the first step to receive a new channel ETT section (S40).

As a result of the decision (S30), if the two source identification's are equal to each other, it is decided that the received channel ETT section is the specific ETT section. And, it goes to a next step. So, the section-filtering process by the header in the demultiplexer 30 is completed.

Hence, the above-explained steps S10 to S40 correspond to the explanation of the section-filtering by filtering the header in the demultiplexer 30 controlled by the PSI/PSIP decoder 80. A process for parsing and processing channel ETT sections received by the section-filtering is explained as follows. In this case, the parsing is performed by the PSI/PSIP decoder 80.

First of all, as a result of the decision (S30), if the two source identification's are equal to each other, it is decided that a received channel ETT section is a specific channel ETT section. The PSI/PSIP decoder 80 then detects a channel ETT section-out received via the demultiplexer 30 (S50). And, the PSI/PSIP decoder 80 parses a header of the detected channel ETT section again (S60). Moreover, the PSI/PSIP decoder 80 reads out ETM identification, which is actual section data, by parsing a message body of the channel ETT section (S70). An extended text message (ETM) is then stored in the database (DB) (S80).

Through the above-explained processes, one channel ETT section is processed or handled. If there exists another channel ETT section that is not received yet, the above-explained processes are repeated.

FIG. 8B is a flowchart of a process for receiving a specific event ETT section according to the present invention. A process for receiving a specific event ETT section is basically identical to the process explained in FIG. 8A. For convenience of explanation, a section-filtering part different from that of the process of FIG. 8A is explained only and the rest part will refer to the process of FIG. 8A.

Hence, FIG. 8B shows a flowchart of a process of deciding whether event identification filtered at a header of a received event ETT section is equal to event identification which is decoded from EIT to be stored in a database (DB), whereas FIG. 8A shows the flowchart of deciding whether the source identification filtered at the header of the received channel ETT section is equal to the source identification decoded from VCT to be stored in the database (DB).

FIG. 8A or FIG. 8B corresponds to the explanation of the case 1 in FIG. 7. And, the case 2 is explained as follows. In the case 2, the information field value is not set but the ETT table ID extension field has the uniqueness value. FIG. 9 is a flowchart of a process for receiving a new ETT section only by discarding an overlapped ETT section according to the present invention. Besides, as mentioned in the foregoing description, the case 3 of FIG. 3 corresponds to a case that the section-filtering by the header is impossible, of which explanation will be skipped in the following description.

First of all, differing from FIG. 8A or FIG. 8B, FIG. 9 shows that the section-filtering by the header is impossible since the information field is not set. Hence, the receiver detects a received ETT section, parses the detected section, reads out actual ETM, and then stores the read-out ETM in the database (DB). In FIG. 9, the process starts on the assumption of the above case.

Hence, FIG. 9 deals with the case that at least one ETT table ID extension value is stored. In FIG. 9, an overlapped section is discarded but a new ETT section is received only. In FIG. 9, in case that an ETT table ID extension field has a uniqueness value according to the present invention, the field value is used in discarding an overlapped ETT section in receiving a new ETT section containing an ETT table ID extension having a new value only.

In explaining a receiving process of FIG. 9, as a parsing part performed by the PSI/PSIP decoder 80 parsing the message body is equivalent to that of FIG. 7, a section-filtering via filtering of a header different from that of FIG. 8A or FIG. 8B is intensively explained as follows.

As mentioned in the foregoing description, in case that the ETT table ID extension field is ‘0x0000’ (i.e., case 3), the section-filtering by a header in the demultiplexer 30 is impossible. So, the PSI/PSIP decoder 80 directly parses a message body to perform the filtering, which is equivalent to the aforesaid description.

The case 2, in which the information field is not set and an ETT section having a uniqueness value (except ‘0x0000’) written in the ETT table ID extension field is received, is explained as follows. A corresponding PID is assigned to an ETT section received to perform a section-filtering by a header on the received ETT section. And, the filtering is carried out in a manner of receiving the ETT section having the assigned PID only.

In the present invention, a condition of receiving an ETT section containing an ETT table ID extension field having a uniqueness value written therein only is appended to the received ETT section having met the former condition. In this case, the uniqueness value means one of a uniqueness, source identification, or event identification.

This is to only receive the ETT section that contains the ETT table ID extension field having the uniqueness value. The latter condition is given to exclude the case 3 that the ETT table ID extension field is ‘0x0000’. On the two conditions, the demultiplexer 30 performs the section-filtering by filtering the header. Hence, the receiver can only receive the ETT section that meets the two conditions (S210).

Once the ETT section meeting the two conditions is received, it is decided whether the uniqueness value of the ETT table ID extension field of the received section is an overlapped field value. In this case, it is assumed that at least one uniqueness value of the ETT table ID extension field of the received ETT section is stored in the database (DB) of FIG. 6. Hence, to decide whether the received section is an overlapped section, it is decided whether a uniqueness ETT table ID extension field value X1˜Xn stored in the database (DB) of FIG. 6 is equal to the uniqueness value of the ETT table ID extension field of the received ETT section.

As the process in FIG. 9 is repeated in the decision process, the stored uniqueness values keep being accumulated. So, the uniqueness values to be compared will increase in deciding the equality of a next ETT section. Namely, a plurality of the uniqueness values will be stored in the database (DB) to be an overlapping decision target (S220).

As a result of the decision, if the uniqueness values of the ETT table ID extension fields of the two ETT sections are equal to each other, the ETT section is decided as an overlapped section that was already received and is then discarded (S230). As a result of the decision, if the uniqueness values of the ETT table ID extension fields of the two ETT sections are not equal to each other, the ETT section is decided as a new section that was not already received. It goes then to a next step. So, the section-filtering performed by the demultiplexer 30 is completed.

Subsequent steps correspond to a parsing and handling process conducted by the PSI/PSIP decoder 80, which is identical to that of FIG. 8A and of which explanation is skipped in the following description.

Thus, FIG. 8A and FIG. 8B correspond to the explanation of the case 1 of receiving a specific ETT section only in FIG. 7 and FIG. 9 corresponds to the explanation of the case 2 of receiving a new ETT section only by discarding an overlapped ETT section in FIG. 7. If ETT sections keep being received and filtered to receive a specific ETT section due to failure in receiving the specific ETT section in FIG. 8A or FIG. 8B, overlapped sections may be generated from the received sections. In this case, the process for receiving a new ETT section only by discarding an overlapped ETT section in FIG. 9 is utilized together to raise processing efficiency of the receiver.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital television (DTV) signal for use in a digital television (DTV) receiver, the digital television (DTV) signal comprising:
an event extended text table (ETT) including a header and a message body, the header including a table identification (ID) extension field which serves to establish uniqueness of the event ETT, the message body including an extended text message (ETM), wherein the table ID extension field includes an event identification of an event associated with the event ETT, and wherein the header further includes an information field indicating that the table ID extension field includes the event identification to establish the uniqueness of the event ETT.

2. The digital television (DTV) signal of claim 1, wherein the information field has an unsigned integer value which is set to 0.

3. The digital television (DTV) signal of claim 1, wherein the event identification specifies a unique identification number of the event associated with the event ETT.

4. The digital television (DTV) signal of claim 1, wherein the ETM included in the message body provides detailed descriptions of the event associated with the event ETT.

5. The digital television (DTV) signal of claim 1, wherein the table ID extension field further includes ETM location information which specifies an existence and location of the ETM.

6. The digital television (DTV) signal of claim 1, further comprising:
an event information table (EIT) corresponding to the event ETT, wherein the EIT includes title and time information of the event associated with the event ETT.

7. The digital television (DTV) signal of claim 1, wherein the message body further includes an additional information field specifying a unique identifier of the ETM.

8. The digital television (DTV) signal of claim 7, wherein a part of the unique identifier of the ETM is assigned to the event identification.

9. The digital television (DTV) signal of claim 8, wherein another part of the unique identifier of the ETM is assigned to source identification of a virtual channel carrying the event associated with the event ETT.

10. The digital television (DTV) signal of claim 9, wherein the source identification specifies a programming source of the virtual channel carrying the event associated with the event ETT.

11. A digital television (DTV) signal for use in a digital television (DTV) receiver, the digital television (DTV) signal comprising:
a channel extended text table (ETT) including a header and a message body, the header including a table identification (ID) extension field which serves to establish uniqueness of the channel ETT, the message body including an extended text message (ETM), wherein the table ID extension field includes a source identification of a virtual channel associated with the channel ETT, and wherein the header further includes an information field indicating that the table ID extension field includes the source identification to establish the uniqueness of the channel ETT.

12. The digital television (DTV) signal of claim 11, wherein the information field has an unsigned integer value which is set to 0.

13. The digital television (DTV) signal of claim 11, wherein the source identification specifies a programming source of the virtual channel associated with the channel ETT.

14. The digital television (DTV) signal of claim 11, wherein the ETM included in the message body provides detailed descriptions of the virtual channel associated with the channel ETT.

15. The digital television (DTV) signal of claim 11, wherein the message body further includes an additional information field specifying a unique identifier of the ETM.

16. The digital television (DTV) signal of claim 15, wherein the unique identifier of the ETM is assigned to the source identification.

17. A digital television signal for use in a digital television receiver, the digital television signal comprising:
an event extended text table (ETT) including a first header and a first message body, the header including a first table identification (ID) extension field which establishes uniqueness of the event ETT, the first message body including a first extended text message (ETM), the first table ID extension field including an event identification of an event associated with the event ETT, wherein the first header further includes a first information field indicating that the first table ID extension field includes the event identification to establish the uniqueness of the event ETT; and
a channel extended text table (ETT) including a second header and a second message body, the second header including a second table identification (ID) extension field which establishes uniqueness of the channel ETT, the second message body including a second extended text message (ETM), the second table ID extension field including a source identification of a virtual channel associated with the channel ETT, wherein the second header further includes a second information field indicating that the second table ID extension field includes the source identification to establish the uniqueness of the channel ETT.

18. A method of processing a digital television (DTV) signal in a digital television (DTV) receiver, the method comprising:
receiving a digital television (DTV) signal;
demodulating the digital television signal, the demodulated signal including a plurality of extended text tables (ETTs); and
detecting at least one pertinent ETT by section-filtering the plurality of ETTs using their PIDs and table identification (ID) extension fields, wherein each of the plurality of ETTs comprises a header containing a table ID extension field which serves to establish uniqueness of each ETT, and wherein the plurality of ETTs are section-filtered based on a first condition that an information field included in a header of the at least one pertinent ETT has a predefined value.

19. The method of claim 18, wherein the predefined value of the information field is 0.

20. The method of claim 18, wherein the information field having the predefined value indicates that a table ID extension field included in the at least one pertinent ETT includes an event identification to establish uniqueness of the at least one pertinent ETT.

21. The method of claim 18, wherein the plurality of ETTs are further section-filtered based on a second condition that the at least one pertinent ETT has a common PID value.

22. The method of claim 21, wherein the plurality of ETTs are further section-filtered based on a third condition that a table ID extension field included in the at least one pertinent ETT includes a specific event identification.

23. The method of claim 22, wherein the event identification specifies a unique identification number of an event associated with the at least one pertinent ETT.

24. The method of claim 22, wherein the at least one pertinent ETT includes an extended text message (ETM) which provides detailed descriptions of an event identified by the specific event identification.

25. The method of claim 18, wherein the information field having the predefined value indicates that a table ID extension field included in the at least one pertinent ETT includes a source identification to establish uniqueness of the at least one pertinent ETT.

26. The method of claim 21, wherein the plurality of ETTs are further section-filtered based on a third condition that a table ID extension field included in the at least one pertinent ETT includes a specific source identification.

27. The method of claim 25, wherein the source identification specifies a programming source of a virtual channel associated with the at least one pertinent ETT.

28. The method of claim 25, wherein the at least one pertinent ETT includes an extended text message (ETM) which provides detailed descriptions of a virtual channel identified by the specific source identification.

29. A digital television (DTV) receiver comprising:
a tuner tuned to receive a digital television (DTV) signal;
a demodulator arranged to demodulate the DTV signal, the demodulated signal including a plurality of extended text tables (ETTs); and
a section-filtering unit arranged to detect at least one pertinent ETT by section-filtering the plurality of ETTs using their PIDs and table identification (ID) extension fields, wherein each of the plurality of ETTs comprises a header containing a table ID extension field which serves to establish uniqueness of each ETT, and wherein the plurality of ETTs are section-filtered based on a first condition that an information field included in a header of the at least one pertinent ETT has a predefined value.

30. The digital television (DTV) receiver of claim 29, wherein the information field having the predefined value indicates that a table ID extension field included in the at least one pertinent ETT includes an event identification to establish uniqueness of the at least one pertinent ETT.

31. The digital television (DTV) receiver of claim 30, wherein the event identification specifies a unique identification number of an event associated with the at least one pertinent ETT.

32. The digital television (DTV) receiver of claim 29, wherein the information field having the predefined value indicates that a table ID extension field included in the at least one pertinent ETT includes a source identification to establish uniqueness of the at least one pertinent ETT.

33. The digital television (DTV) receiver of claim 32, wherein the source identification specifies a programming source of a virtual channel associated with the at least one pertinent ETT.

34. The digital television (DTV) receiver of claim 29, wherein the section-filtering unit is a demultiplexer.

35. The digital television (DTV) receiver of claim 29, further comprising:
a decoder arranged to parse the at least one pertinent ETT detected from the section-filtering unit; and
a data storage arranged to store an extended text message (ETM) included in the parsed ETT.
